(19) United States
(12) Patent Application Publication
(10) Pub. No.: US 2015/0027879 A1
(43) Pub. Date: Jan. 29, 2015

(54) SYSTEM AND METHOD FOR TREATING AQUEOUS SOLUTIONS AND CONTAMINANTS THEREIN

(71) Applicant: AquaMost, Inc., Madison, WI (US)

(72) Inventors: JAKE MYRE, Beaver Dam, WI (US); Terence P. Barry, Middleton, WI (US); Edward Andrews, Brookfield, WI (US); Craig Doolittle, Monona, WI (US); Alan Carlson, Columbus, WI (US); Anton Asmuth, Madison, WI (US)

(21) Appl. No.: 14/508,421

(22) Filed: Oct. 7, 2014

Related U.S. Application Data
(63) Continuation-in-part of application No. 14/177,314, filed on Feb. 11, 2014.
Application No. 14/177,314 is a continuation-in-part of application No. 14/035,993, filed on Sep. 25, 2013.
Application No. 14/035,993 is a continuation of application No. 13/769,741, filed on Feb. 18, 2013, now Pat. No. 8,568,573.
Application No. 13/769,741 is a continuation of application No. 13/544,721, filed on Jul. 9, 2012, now Pat. No. 8,398,828.
Application No. 13/544,721 is a continuation-in-part of application No. 14/150,915, filed on Jan. 9, 2014.
Application No. 14/150,915 is a continuation of application No. 13/899,993, filed on May 22, 2013, now Pat. No. 8,663,471.
Application No. 13/899,993 is a continuation of application No. 13/796,310, filed on Mar. 12, 2013, now Pat. No. 8,658,035.
Application No. 13/796,310 is a continuation of application No. 13/689,089, filed on Nov. 29, 2012, now Pat. No. 8,658,046.
(60) Provisional application No. 61/887,777, filed on Oct. 7, 2013.
(60) Provisional application No. 61/930,337, filed on Jan. 22, 2014.
(60) Provisional application No. 61/812,990, filed on Apr. 17, 2013.
(60) Provisional application No. 61/782,969, filed on Mar. 14, 2013.
(60) Provisional application No. 61/763,336, filed on Feb. 11, 2013.
(60) Provisional application No. 61/613,357, filed on Mar. 20, 2012.
(60) Provisional application No. 61/583,974, filed on Jan. 6, 2012.
(60) Provisional application No. 61/566,490, filed on Dec. 2, 2011.
(60) Provisional application No. 61/584,012, filed on Jan. 6, 2012.

(51) Int. Cl. C02F 1/467

(52) U.S. Cl. CPC C02F 1/4672
USPC 204/260; 204/242; 204/252

(57) ABSTRACT

The present disclosure is generally directed to point of service devices and methods of treating aqueous solutions to help remove or otherwise reduce levels, concentrations or amounts of one or more contaminants. The present disclosure relates to a system including an apparatus including a substantially self-contained housing or container which is adapted to receive components including at least one counterelectrode (e.g. cathode) and at least one photoelectrode (e.g. anode) provided or arranged around at least one UV light source, and/or receive, contain and/or circulate fluid or aqueous solution.

### CROSS REFERENCE TO RELATED APPLICATIONS

This application claims priority to U.S. Provisional Patent Application Ser. No. 61/887,777, filed Oct. 7, 2013, entitled “System and Method for Treating Aqueous Solutions and Contaminants Therein,” and is a continuation-in-part of U.S. patent application Ser. No. 14/177,314, filed Feb. 11, 2014, entitled “Apparatus and Method for Treating Aqueous Solutions and Contaminants Therein,” which claims priority to U.S. Provisional Patent Application Ser. Nos. 61/930,337 filed Jan. 22, 2014, 61/812,990 filed Apr. 17, 2013, 61/782,969 filed Mar. 14, 2013, and 61/763,336 filed Feb. 11, 2013; and is a Continuation-in-Part of U.S. patent application Ser. No. 14/035,993, filed Sep. 25, 2013, entitled “Apparatus and Method for Treating Aqueous Solutions and Contaminants Therein,” which is a Continuation Application of U.S. patent application Ser. No. 13/769,741, filed Feb. 18, 2013, now U.S. Pat. No. 8,568,573, which is a Continuation Application of U.S. patent application Ser. No. 13/544,721, filed Jul. 9, 2012, now U.S. Pat. No. 8,398,828, which claims priority to U.S. Provisional Patent Application Ser. No. 61/613,357, filed Mar. 20, 2012 and U.S. Provisional Patent Application Ser. No. 61/583,974, filed Jan. 6, 2012; and is a Continuation-in-Part of U.S. patent application Ser. No. 14/150,915, filed Jan. 9, 2014, entitled “Apparatus and Method for Treating Aqueous Solutions and Contaminants Therein,” which is a Continuation Application of U.S. patent application Ser. No. 13/899,993, filed May 22, 2013, now U.S. Pat. No. 8,663,471, which is a Continuation Application of U.S. patent application Ser. No. 13/796,310, filed Mar. 12, 2013, now U.S. Pat. No. 8,658,035, which is a Continuation Application of U.S. patent application Ser. No. 13/689,089, filed Nov. 29, 2012, now U.S. Pat. No. 8,658,046, which claims priority to U.S. Provisional Patent Application Ser. No. 61/584,012, filed Jan. 6, 2012 and U.S. Provisional Patent Application Ser. No. 61/566,490, filed Dec. 2, 2011; each of which is hereby incorporated herein by reference in its entirety.

### BACKGROUND

Aqueous solutions often contain one or more contaminants. Such aqueous solutions include, but are not limited to, groundwater, seawater, wastewater, drinking water, and aquaculture (e.g., aquarium water and aquaculture water).

Groundwater includes water that occurs below the surface of the Earth, where it occupies spaces in soils or geologic strata. Groundwater may include water that supplies aquifers, wells and springs.

Wastewater may be any water that has been adversely affected in quality by effects, processes, and/or materials derived from human or non-human activities. For example, wastewater may be water used for washing, flushing, or in a manufacturing process, that contains waste products. Wastewater may further be sewage that is contaminated by feces, urine, bodily fluids and/or other domestic, municipal or industrial liquid waste products that is disposed of (e.g., via a pipe, sewer, or similar structure or infrastructure or via a cesspool emptier). Wastewater may originate from blackwater, cesspit leakage, septic tanks, sewage treatment, washing water (also referred to as “graywater”), rainfall, groundwater infiltrated into sewage, surplus manufactured liquids, road drainage, industrial site drainage, and storm drains, for example.

Drinking water includes water intended for supply, for example, to households, commerce and/or industry. Drinking water may include water drawn directly from a tap or faucet. Drinking water may further include sources of drinking water supplies such as, for example, surface water and groundwater.

Aquarium water includes, for example, freshwater, seawater, and saltwater used in water-filled enclosures in which fish or other aquatic plants and animals are kept or intended to be kept. Aquarium water may originate from aquariums of any size such as small home aquariums up to large aquariums (e.g., aquariums holding thousands to hundreds of thousands of gallons of water).

Aquaculture water is water used in the cultivation of aquatic organisms. Aquaculture water includes, for example, freshwater, seawater, and saltwater used in the cultivation of aquatic organisms.

A contaminant may be, for example, an organism, an organic chemical, an inorganic chemical, and/or combinations thereof. More specifically, “contaminant” may refer to any compound that is not naturally found in an aqueous solution. Contaminants may also include microorganisms that may be naturally found in an aqueous solution and may be considered safe at certain levels, but may present problems (e.g., disease and/or other health problems) at different levels. In other cases (e.g., in the case of ballast water), contaminants also include microorganisms that may be naturally found in the ballast water at its point of origin, but may be considered non-native or exotic species. Moreover, governmental agencies such as the United States Environmental Protection Agency, have established standards for contaminants in water.

A contaminant may be an organism or a microorganism. The microorganism may be for example, a prokaryote, a eukaryote, and/or a virus. The prokaryote may be, for example, pathogenic prokaryotes and fecal coliform bacteria. Example prokaryotes may be Escherichia, Brucella, Legionella, sulfate reducing bacteria, acid producing bacteria, Cholera bacteria, and combinations thereof.

Example eukaryotes may be a protist, a fungus, or an algae. Example protists (protozoans) may be Giardia, Cryptosporidium, and combinations thereof. A eukaryote may also be a pathogenic eukaryote. Also contemplated within the disclosure are cysts of cyst-forming eukaryotes such as, for example, Giardia.

A eukaryote may also include one or more disease vectors. A “disease vector” refers any agent (person, animal or microorganism) that carries and transmits an infectious pathogen into another living organism. Examples include, but are not limited to, an insect, nematode, or other organism that transmits an infectious agent. The life cycle of some invertebrates such as, for example, insects, includes time spent in water. Female mosquitoes, for example, lay their eggs in water. Other invertebrates such as, for example, nematodes, may deposit eggs in aqueous solutions. Cysts of invertebrates may also contaminate aqueous environments. Treatment of aqueous solutions in which a vector (e.g., disease vector) may reside may thus serve as a control mechanism for both the disease vector and the infectious agent.

A contaminant may be a virus. Example viruses may include a waterborne virus such as, for example, enteric viruses, hepatitis A virus, hepatitis E virus, rotavirus, and MS2 coliphage, adenovirus, and norovirus.

A contaminant may include an organic chemical (e.g., voc). The organic chemical may be any carbon-containing substance according to its ordinary meaning. The organic chemical may be, for example, chemical compounds, pharmaceuticals, over-the-counter drugs, steroids, dyes, agricultural pollutants, herbicides, industrial pollutants, proteins, endocrine disruptors, fuel oxygenates, and/or personal care products. Examples of organic chemicals may include acetone, acid blue 9, acid yellow 23, acrylamide, alachlor, atrazine, benzene, benzo(a)pyrene, bromodichloromethane, carbofuran, carbon tetrachloride, chlorobenzene, chlorodane, chloroform, chloromethane, 2,4-dichlorophenoxyacetic acid, dalapon, 1,2-dibromo-3-chloropropane, o-dichlorobenzene, p-dichlorobenzene, 1,2-dichloroethane, 1,1-dichloroethylene, cis-1,2-dichloroethylene, trans-1,2-dichloroethylene, dichlormethane, 1,2-dichloropropane, di(2-ethylhexyl)adipate, di(2-ethylhexyl)phthalate, dinoseb, dioxin (2,3,7,8-TCDD), diquat, endothall, endrin, epichlorohydrin, ethylbenzene, ethylene dibromide, ethynylestradiol, glyphosate, a haloacetic acid, heptachlor, heptachlor epoxide, hexachlorobenzene, hexachlorocyclopentadiene, lindane, methyl-tertiary-butyl ether, methyoxychlor, napthoxamyl (vydate), naphthalene, pentachlorophenol, phenol, picloram, isopropylbenzene, N-butylbenzene, N-propylbenzene, Sec-butylbenzene, polychlorinated biphenyls (PCBs), simazine, sodium phenoxyacetic acid, styrene, tetrachloroethylene, toluene, toxaphene, 2,4,5-TP (silvex), 1,2,4-trichlorobenzene, 1,1,1-trichloroethane, 1,1,2-trichloroethane, trichloroethylene, a trihalomethane, 1,2,4-trimethylbenzene, 1,3,5-trimethylbenzene, vinyl chloride, o-xylene, m-xylene, p-xylene, a G-series nerve agent, a V-series nerve agent, bisphenol-A, bovine serum albumin, carbamazepine, cortisol, estradiol-17β, gasoline, gelbstoff, triclosan, ricin, a polybrominated diphenyl ether, a polychlorinated diphenyl ether, and a polychlorinated biphenyl. Methyl tert-butyl ether (also known as, methyl tertiary-butyl ether) is a particularly applicable organic chemical contaminant.

A contaminant may include an inorganic chemical. More specifically, the contaminant may be a nitrogen-containing inorganic chemical such as, for example, ammonia (NH₃) or ammonium (NH₄). Contaminants may include non-nitrogen-containing inorganic chemicals such as, for example, aluminum, antimony, arsenic, asbestos, barium, beryllium, bromate, cadmium, chloramine, chlorine, chlorine dioxide, chlorite, chromium, copper, cyanide, fluoride, iron, lead, manganese, mercury, nickel, nitrate, nitrite, selenium, silver, sodium, sulfate, thallium, and/or zinc.

A contaminant may include a radionuclide. Radioactive contamination may be the result of a spill or accident during the production or use of radionuclides (radioisotopes). Example radionuclides include, but are not limited to, an alpha photon emitter, a beta photon emitter, radium 226, radium 228, and uranium.

Various methods exist for handling contaminants and contaminated aqueous solutions. Generally, for example, contaminants may be contained to prevent them from migrating from their source, removed, and immobilized or detoxified.

Another method for handling contaminants and contaminated aqueous solutions is to treat the aqueous solution at its point-of-use. Point-of-use water treatment refers to a variety of different water treatment methods (physical, chemical and biological) for improving water quality for an intended use such as, for example, drinking, bathing, washing, irrigation, etc., at the point of consumption instead of at a centralized location. Point-of-use treatment may include water treatment at a more decentralized level such as a small community or at a household. A drastic alternative is to abandon use of the contaminated aqueous solutions and use an alternative source.

A more commonly used method of treating aqueous solutions for disinfection of microorganisms is chemically treating the solution with chlorine. Disinfection with chlorine, however, has several disadvantages. For example, chlorine content must be regularly monitored, formation of undesirable carcinogenic by-products may occur, chlorine has an unpleasant odor and taste, and chlorine requires the storage of water in a holding tank for a specific time period.

There is a need in the art for alternative approaches for treating aqueous solutions to remove and/or reduce amounts of contaminants. Specifically, it would be advantageous to have apparatus and/or methods for treating various aqueous solutions including high-salinity water, groundwater, seawater, wastewater, drinking water, aquarium water, and aquaculture water, and/or for preparation of ultrapure water for laboratory use and remediation of textile industry dye waste water, among others, that help remove or eliminate contaminants without the addition of chemical constituents, the production of potentially hazardous by-products, or the need for long-term storage.

### SUMMARY

The disclosure provides a system for removing or reducing the level of contaminants in a solution comprising: a pump, a tank, a carbon filter, and a photoelectrocatalytic oxidation apparatus in fluid communication; wherein the photoelectrocatalytic oxidation apparatus comprises: a housing having first opposing end and a second opposing end and at least partially defining a cavity having a cavity wall and a cavity length; a light tube provided within the cavity and adapted to help disburse or otherwise provide ultraviolet radiation over most of the cavity length; a photoelectrode provided around the light tube; a counterelectrode provided in the space between the photoelectrode and the cavity wall, and a separator provided between the photoelectrode and counterelectrode; wherein the photoelectrode comprises a primarily titanium foil support with a layer of titanium dioxide provided on at least one surface the photoelectrode; and wherein the photoelectrode and counterelectrode are each coupled to a respective terminal adapted to be electrically coupled to a power supply.

The disclosure further provides a system for removing or reducing the level of contaminants in a solution comprising: a pump, a tank, and a carbon filter in fluid communication with a photoelectrocatalytic oxidation device; wherein the photoelectrocatalytic oxidation device comprises: a housing having a first end opposing a second and at least partially defining a cavity having a cavity wall and a cavity length; a light tube provided within the cavity and adapted to help disburse or otherwise provide ultraviolet radiation over most of the cavity length; a photoelectrode provided around the light tube, such that a portion of the light tube is received by the photoelectrode; a separator provided around the photoelectrode, such that a portion of the photoelectrode is received by the separator; and a counterelectrode provided around the separator, such that a portion of the separator is received by the counterelectrode; wherein the photoelectrode comprises a primarily titanium foil support with a layer of titanium dioxide provided on at least one surface of the photoelectrode; and wherein the photoelectrode and counterelectrode are each coupled to a respective terminal adapted to be electrically coupled to a power supply.

The disclosure further provides a system for reducing the level of contaminants in a solution comprising: a pump, a tank, and a carbon filter in fluid communication with a photoelectrocatalytic oxidation device, the device comprising: a housing defining a cavity, the cavity having a first cavity end opposing a second cavity end; a light tube containing an ultraviolet light source provided in the cavity between the first and second cavity ends; a photoelectrode provided in the cavity between the first and second cavity ends, the photoelectrode receives the light tube such that the photoelectrode substantially surrounds the light tube; and a counterelectrode provided in the cavity between the first and second cavity ends, the counterelectrode receives the photoelectrode such that the counterelectrode substantially surrounds the photoelectrode and light tube.

### BRIEF DESCRIPTION OF THE DRAWINGS

The disclosure will be better understood, and features, aspects and advantages other than those set forth above will become apparent when consideration is given to the following detailed description thereof. Such detailed description makes reference to the following drawings, wherein:

FIG. 1 is a schematic illustration of a point of service drinking water system, according to one or more examples of embodiments.

FIG. 2 is a perspective view of a point of service drinking water system, according to one or more examples of embodiments.

FIG. 3 is a perspective view of a point of service drinking water system, device or apparatus, according to one or more examples of embodiments.

FIG. 4 is a cut-away perspective view of a point of service drinking water system, device or apparatus, according to one or more examples of embodiments.

FIG. 5 is an exploded perspective view of a PECO device or apparatus of a point of service drinking water system, according to one or more examples of embodiments.

FIG. 6 is a side view of a PECO device or apparatus of a point of service drinking water system, according to one or more examples of embodiments.

FIG. 7 is a top view of the device or apparatus illustrated in FIG. 6, according to one or more examples of embodiments.

FIG. 8 is an end view of the device or apparatus illustrated in FIG. 6, according to one or more examples of embodiments.

FIG. 9 is a partial cross-sectional isometric view of a PECO device or apparatus, according to one or more examples of embodiments.

FIG. 10 is a partial cross-sectional isometric view of a PECO device or apparatus, according to one or more examples of embodiments.

FIG. 11 is a partial cross-sectional view of the device or apparatus illustrated in FIG. 10, according to one or more examples of embodiments.

FIG. 12 is a partial cross-sectional view of a PECO device or apparatus, according to one or more examples of embodiments.

FIG. 13 is an isometric view of a spacer of a PECO device or apparatus, according to one or more examples of embodiments.

FIG. 14 is an exit end view of the spacer illustrated in FIG. 13, according to one or more examples of embodiments.

FIG. 15 is an entrance end view of the spacer illustrated in FIG. 13, according to one or more examples of embodiments.

FIG. 16 is a cross-sectional view of the spacer illustrated in FIG. 13, according to one or more examples of embodiments.

While the disclosure is susceptible to various modifications and alternative forms, specific embodiments thereof have been shown by way of example in the drawings and are herein described below in detail. For example, any numbers, measurements, and/or dimensions illustrated in the Figures are for purposes of example only. Any number, measurement or dimension suitable for the purposes provided herein may be acceptable. It should be understood that the description of specific embodiments is not intended to limit the disclosure from covering all modifications, equivalents and alternatives falling within the spirit and scope of the disclosure.

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein may be used in the practice or testing of the present disclosure, example methods and materials are described below.

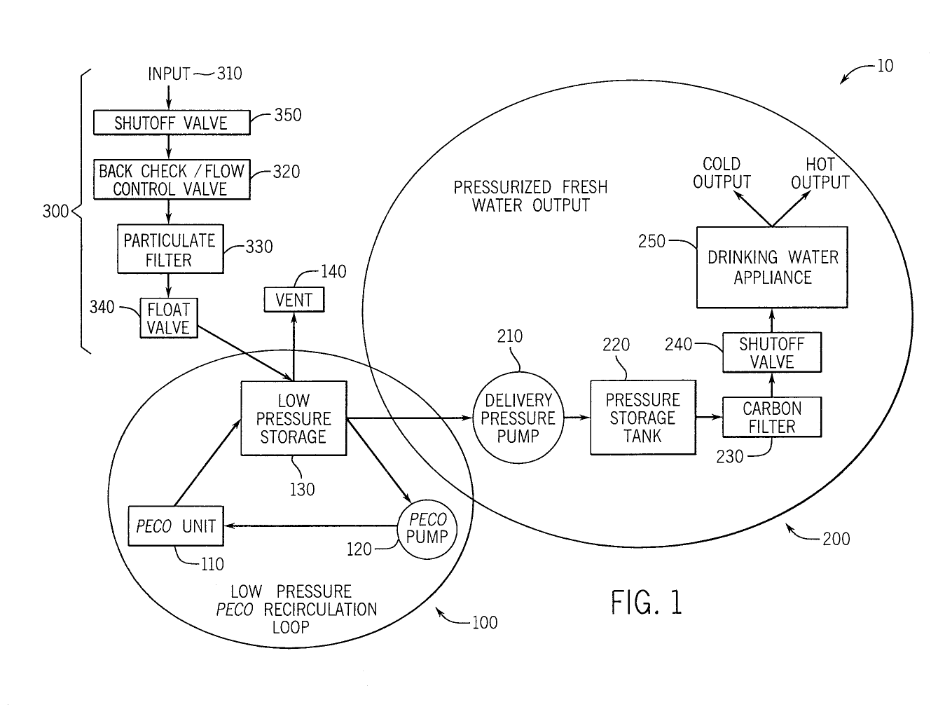

Referring now to FIG. 1, an example embodiment of a system 10 for treating aqueous solutions and contaminants therein. In various embodiments, system 10 includes a photoelectric catalytic oxidation (PECO) system, apparatus, or device 110, a power supply (not shown), a first pump 120, a tank 130, and a carbon filter 230. In various embodiments, the system may include additional filters, tanks, and pumps.

In various embodiments, system includes a PECO recirculation loop subsystem 100. In various embodiments, PECO recirculation loop subsystem 100 includes PECO system, apparatus, or device 110 in fluid communication with first pump 120, and tank (e.g., a low-pressure storage tank) 130. Low-pressure storage tank 130 may include a vent 140, and/or otherwise may be vented as necessary or desired.

In various embodiments, system 10 may also include a fresh water output subsystem 200 in fluid communication with PECO recirculation loop subsystem 100. In various embodiments, fresh water output subsystem 200 is pressurized and includes a delivery pressure pump 210, a pressure storage tank 220, and carbon filter 230 in fluid communication. In various embodiments, water output subsystem 200 also includes a drinking water appliance 250 (e.g., a drinking water appliance having a cold output and hot output), such as an Ion 900 series drinking water appliance manufactured by Natural Choice Corporation, Rockford, Ill., in fluid communication with one or more other components of fresh water output subsystem 200.

In various embodiments, system 10 according to various embodiments may also include an input subsystem 300. In various embodiments, the input subsystem includes an input or inlet 310, one or more valves 320/370, and a particulate filter 330 in fluid communication. In various embodiments, particulate filter 330 is a five micron filter, although it should be appreciated that any variety of particulate filters (or combinations of particulate filters) may be utilized in accordance with various embodiments. In various embodiments, input subsystem 300 also includes a shut off valve 350, a back check and/or flow control valve 320, and a float valve 340. In various embodiments, shut off valve 350, back check and/or flow control valve 320, particulate filter 330, and float valve 340 are in fluid communication with each other and the inlet or input 310. In various embodiments, input subsystem 300 is in fluid communication with PECO recirculation loop subsystem 100. For example, low pressure storage tank 130, pump 120, and PECO apparatus or device 110 may be in fluid communication with float valve 340 of the input subsystem 300. More specifically, in various embodiments, float valve 340 is in fluid communication with lower pressure storage tank 130 which is in fluid communication or otherwise coupled to pump 120 which is in fluid communication or otherwise coupled to PECO unit 110 which is in fluid communication or otherwise coupled to storage tank 130 of the recirculation loop subsystem 100.

In various embodiments, low pressure storage tank 130 is in fluid communication or otherwise coupled to delivery pump 210 of output subsystem 200, which may be in fluid communication with pressure storage tank 220, carbon filter 230, shut off valve 240, and/or drinking water appliance 250.

In various embodiments, water or solution from inlet or input 310 passes through open shut off valve 350, and then through back check and/or flow control valve 320 and then through particular filter 330, and then through float valve 340. From float valve 340, in various embodiments, the water or aqueous solution passes to low pressure storage tank 130. The water then circulates from low pressure storage tank 130 to pump 120 and to PECO unit, apparatus, or device 110, and back to low pressure storage tank 130. The water may circulate and/or recirculate between low pressure storage tank 130, pump 120, and PECO unit, apparatus or device 110, as necessary or desired or otherwise dependent upon water demand. From low pressure storage tank 130, water passes in various embodiments to delivery pressure pump 210 and into pressure storage tank 220. In various embodiments, the water then passes from pressure storage tank 220 to filter 230 (e.g., a carbon filter) through open shut off valve 240 and to drinking water appliance 250.

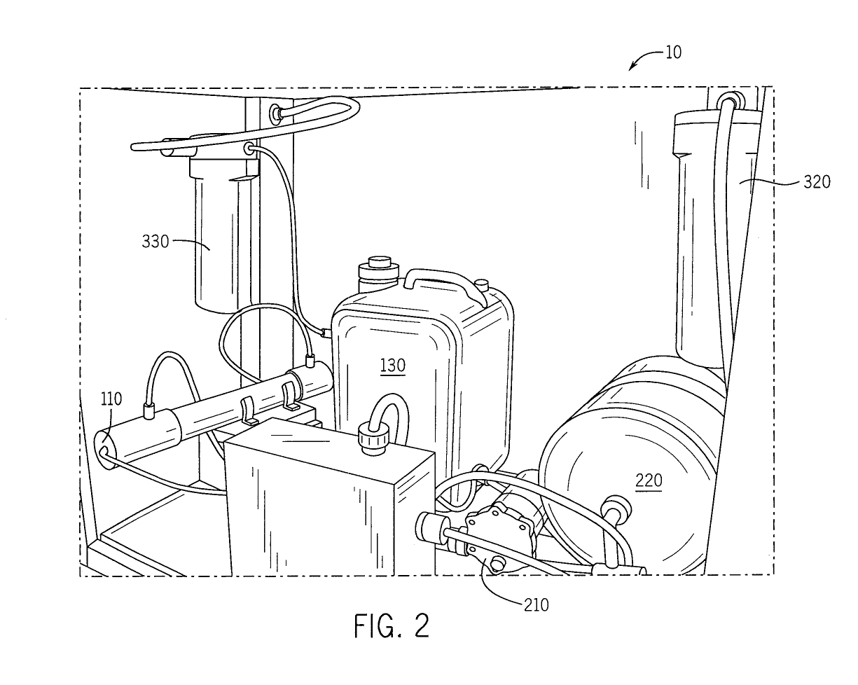

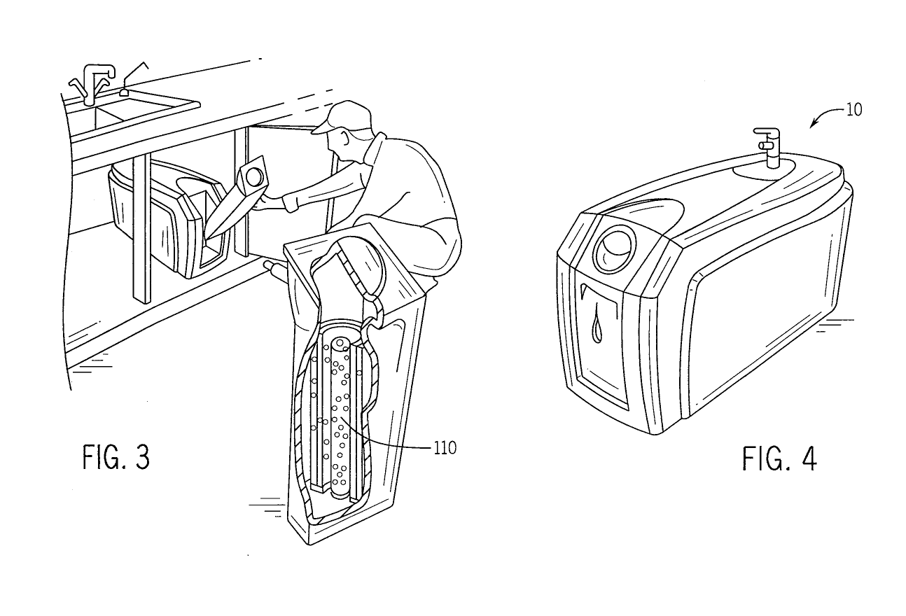

Referring now to FIGS. 2-4, various embodiments of the system according to this disclosure are shown. For example, as shown in FIG. 2, system 10 may include particulate filter 330 in fluid communication with low pressure storage tank 130 in fluid communication with pump 120 and PECO unit 110. Low pressure storage tank 130 may also be in communication with pressure storage tank 220 and carbon filter 230. As shown in FIG. 2, each of the components of the system may be a separate component in fluid communication with the others. As illustrated in FIGS. 3 and 4, however, the components (e.g., PECO unit 110) may be provided in an integrated and/or modular system device or unit. While system 10 is shown in FIGS. 2-3 as being provided at least partially under a sink, it should be appreciated that the system, unit or device may be provided in any variety of locations.

Any variations of a PECO system, apparatus or device may be utilized in accordance with the system of present disclosure. By way of example, the PECO apparatus and devices disclosed in the patents and patent applications identified and incorporated by reference above may be utilized in accordance with the present disclosure.

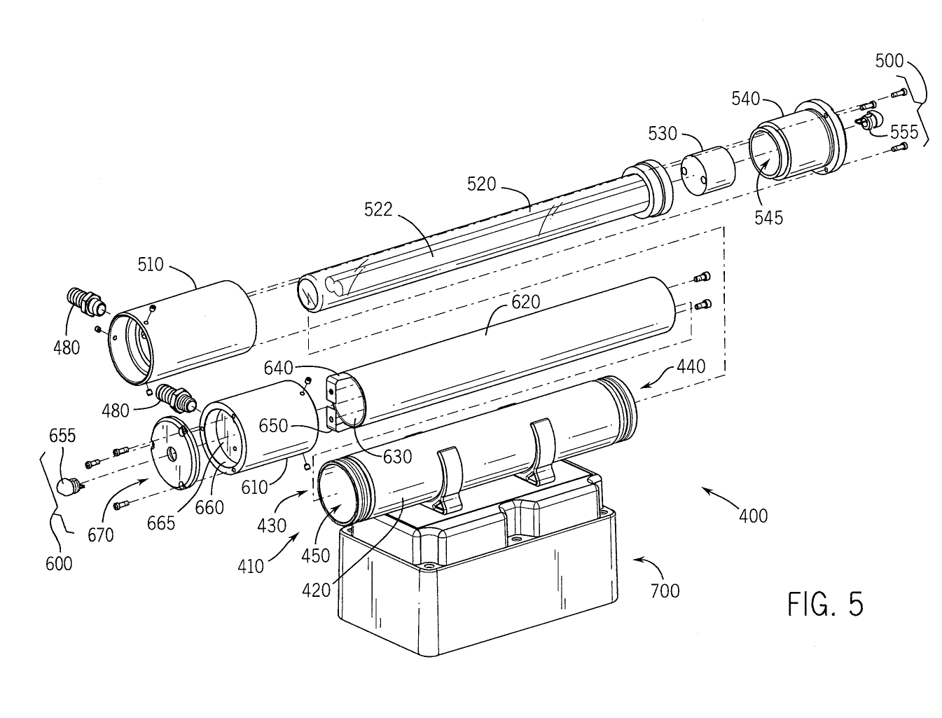

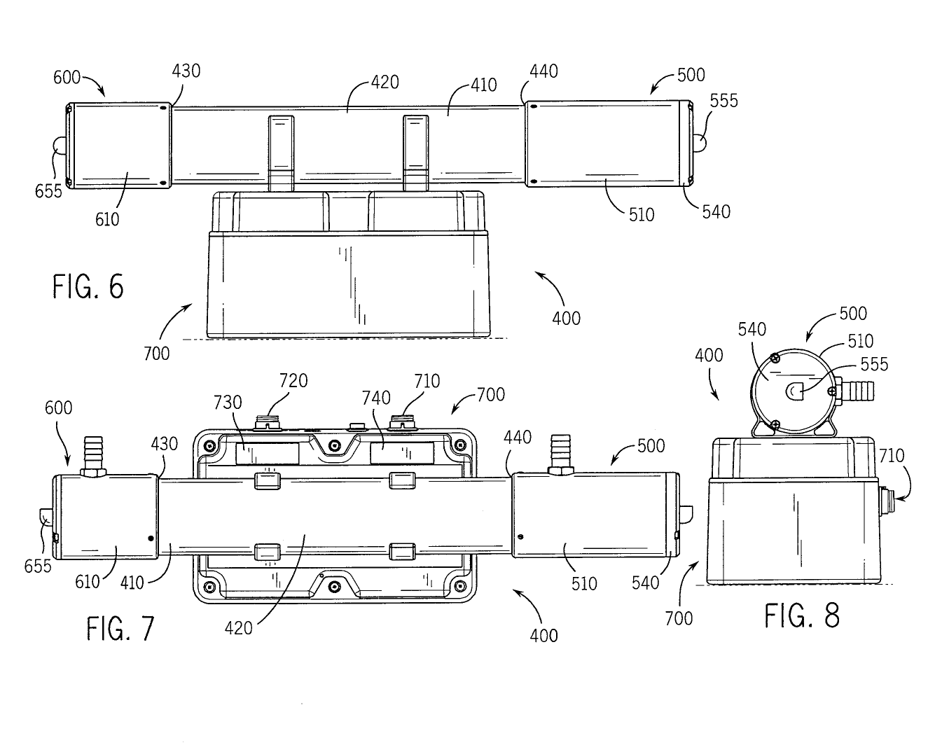

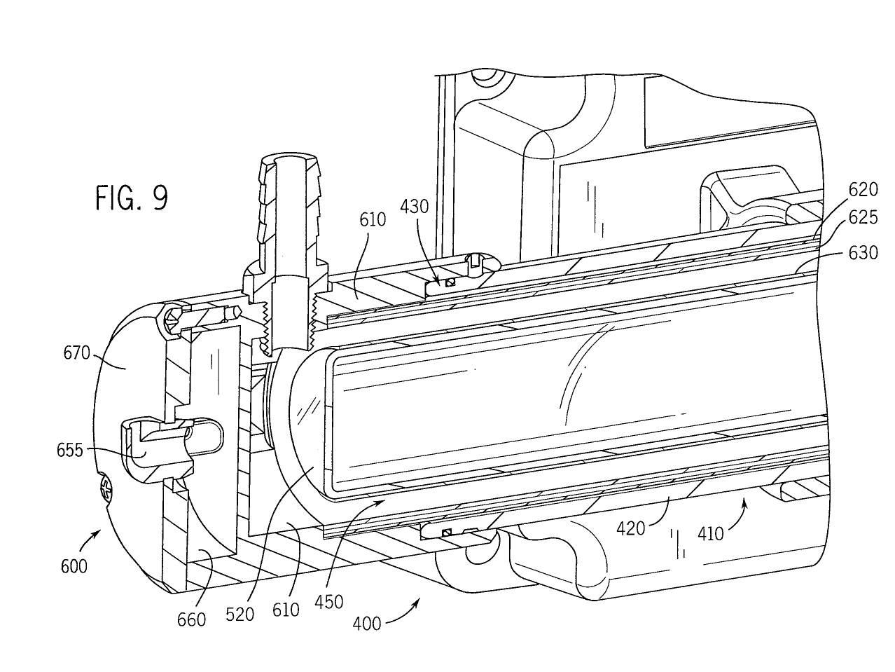

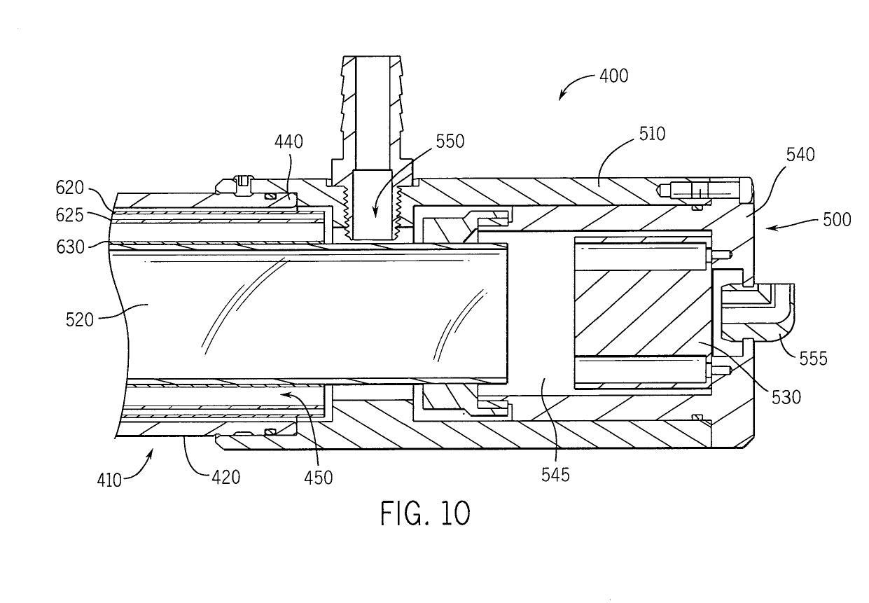

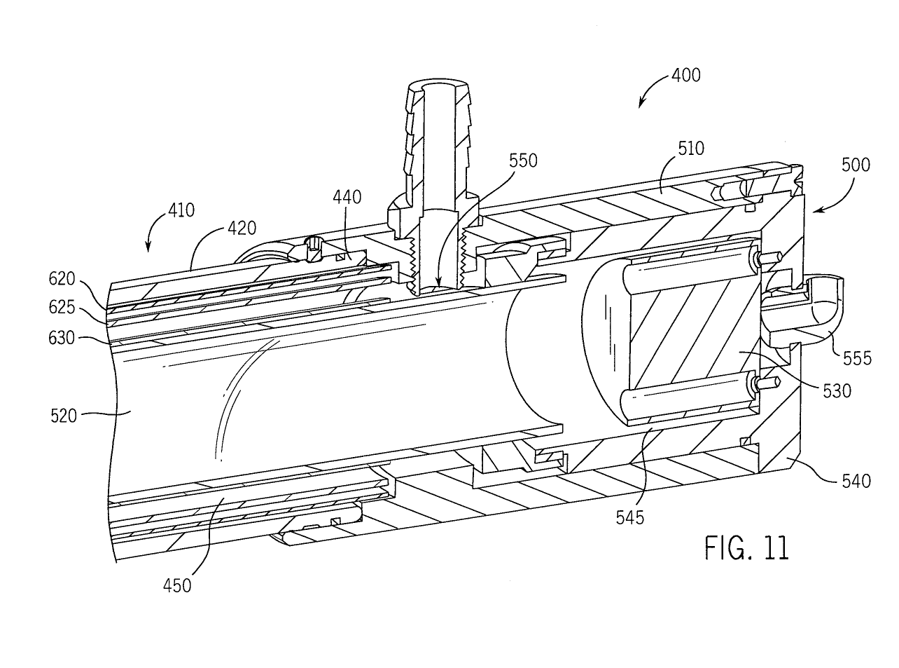

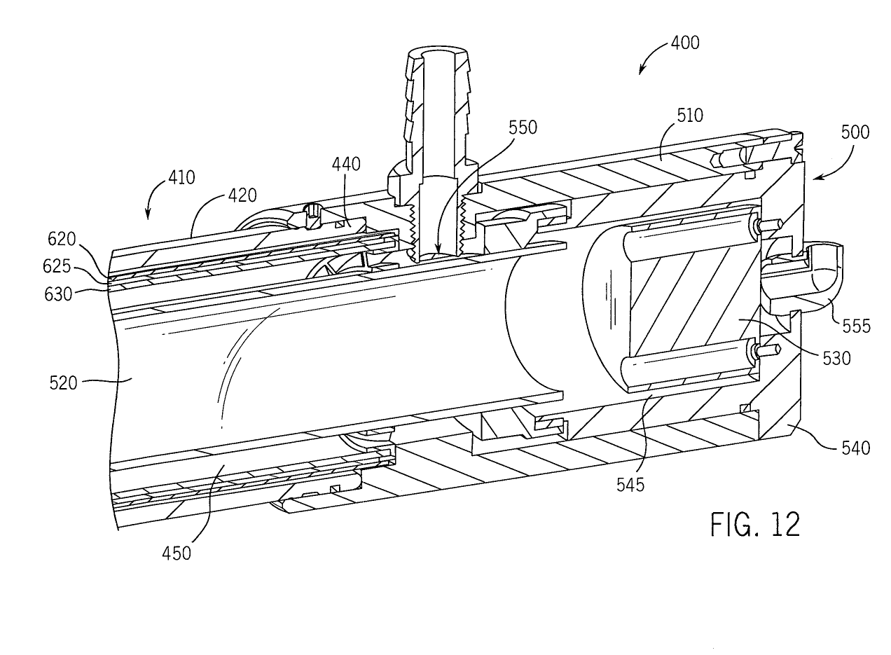

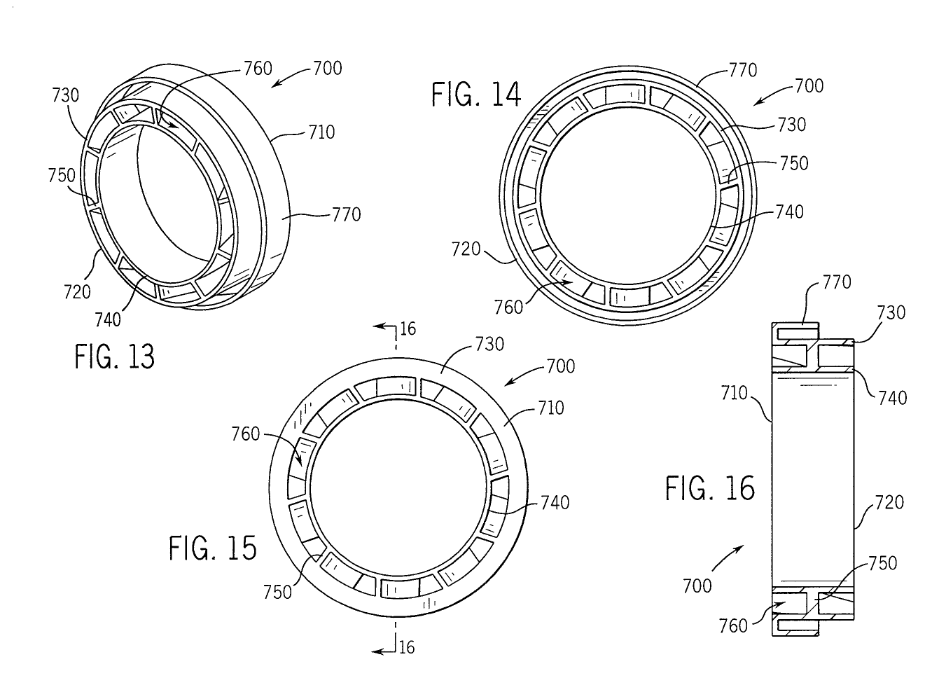

Referring now FIGS. 5-11, various embodiments of system, apparatus, and device (e.g., a photoelectric catalytic oxidation (PECO) system, apparatus, and device) that may be included or utilized with the disclosed system are described. In various embodiments, the device includes and/or is provided in an apparatus or reactor or substantially self-contained device. The device or reactor in various embodiments includes a housing or container which is adapted to receive components (e.g. operative components) of the device and/or receive, contain and/or circulate fluid or aqueous solution. In various embodiments, the container houses at least one counterelectrode (e.g. cathode) and at least one photoelectrode (e.g. anode) provided or arranged around at least one UV light source. In various embodiments, a counterelectrode (e.g. cathode), a photoelectrode (e.g. anode), and a UV light source may be provided in a structure, such as a tubular or annular housing or container. In various embodiments, flow of fluid or solution is facilitated past the photoelectrode and counterelectrode. In various embodiments, one or more power supplies and/or ballasts are included or provided for powering the UV-light source and/or for providing electrical potential to one or more of the counterelectrodes (e.g., cathodes) and photoelectrodes (e.g., anodes). In various embodiments, one or more power supplies and/or ballasts are electrically coupled to UV-light sources and/or electrodes, but provided externally to the container, housing or device.

Generally, in various embodiments, a method for reducing the level or amount of one or more contaminants in solution or fluid described includes introducing the solution into a housing or container or cell including: a UV light; a photoelectrode (e.g., anode), wherein the photoelectrode comprises an anatase polymorph of titanium, a rutile polymorph of titanium, or a nanoporous film of titanium dioxide; and a counterelectrode (e.g., cathode). In various embodiments, the photoelectrode is irradiated with UV light, and a first potential or bias is applied to the photoelectrode and counterelectrode for a first period of time. In various embodiments, a second potential or bias is applied to the photoelectrode and counterelectrode for a second period of time. As a result, in various embodiments, a contaminant level or amount in solution is reduced.

More specifically, an exemplary embodiment of a device 400 (e.g., a PECO device) or apparatus is shown. In various embodiments, device 400 includes a housing 410. The housing may be formed of any suitable material and of any size or shape for any of its intended purposes. In various examples, housing 410 is a molded, high-durability plastic or polyethylene and/or may be formed to be resistant to one or more contaminants. In various embodiments, housing 410 has one or more sidewalls 420 extending between first and second opposing ends 430/440. In various embodiments, housing 410 is generally annular, tubular, cylindrical, or conical. In various embodiments, housing 410 and/or sidewalls 420 define a cavity 450 having a cavity wall. In various embodiments, housing 410 defines a generally annular, tubular, cylindrical, or conical cavity 450. Opposing ends 430/440 may be modified or adapted (e.g., threaded and/or grooved) to help couple or removably couple and/or seal other components or assemblies (such as bulb assembly or module 500 and/or electrode assembly or module 600) to housing 410.

In various embodiments, device 400 (e.g., PECO device or apparatus) includes a bulb assembly or module 500. In various embodiments, bulb assembly 500 includes a bulb assembly member 510, a light tube or sleeve 520, and a bulb socket 530. In various embodiments, bulb assembly 500 includes a bulb end cap 540, and a wiring guide or connector 555. In various embodiments, light tube or sleeve 520 defines a cavity adapted to receive a light source or lamp 522 (e.g., a UV light source). In various embodiments, bulb socket 530 is provided in a cavity 545 defined by bulb end cap 540 and/or coupled to the bulb end cap 540. In various embodiments, bulb end cap 540 is coupled (e.g., threaded onto) to light tube or sleeve 520. In various embodiments, bulb assembly member 510 defines a cavity. In various embodiments, the light tube or sleeve 520, bulb socket 530, and a portion of bulb end cap 540 are provided into and/or through the cavity of bulb assembly member 510, and bulb assembly member 510 is coupled to bulb end cap 540. In various embodiments, bulb assembly member 510 defines an inlet and/or an outlet 550. In various embodiments, a tubing or other adapter 480 is provided in the inlet/outlet defined by bulb assembly member 510. In various embodiments, a light source or lamp 522 (e.g., such as is described above) is provided in and/or coupled (e.g., electrically coupled) to bulb socket 530 and/or at least partially housed within light tube or sleeve 520. In various embodiments, bulb end cap 540 defines an aperture into which wiring guide or connector 555 and/or wiring electrically coupled to bulb socket 530 and/or a light source may be provided. In various embodiments, light tube or sleeve 520 is adapted to disburse, distribute, or otherwise transport or provide light over same, most or all of the length of tube or sleeve 520 and/or some, most, or all of cavity 450.

In various embodiments, the UV light source is a high irradiance UV light bulb. In one or more further examples of embodiments, the UV bulb is a germicidal UV bulb with a light emission in the range of 400 nanometers or less, and more preferably ranging from 250 nanometers to 400 nanometers.

In various embodiments, the ultraviolet light of the UV light source has a wavelength in the range of from about 185 to 380 nm. In one or more examples of embodiments, the light or lamp is a low pressure mercury vapor lamp adapted to emit UV germicidal irradiation at 254 nm wavelength. In one or more alternative examples of embodiments, a UV bulb with a wavelength of 185 nm may be effectively used. Various UV light sources, such as those with germicidal UVC wavelengths (peak at 254 nm) and black-light UVA wavelengths (UVA range of 300-400 nm), may also be utilized. In one or more examples of embodiments, an optimal light wavelength (e.g. for promoting oxidation) is 305 nm. However, various near-UV wavelengths are also effective. Both types of lamps may emit radiation at wavelengths that activate photoelectrocatalysis. The germicidal UV and black light lamps are widely available and may be used in commercial applications of the instant PECO device.

In one or more additional examples of embodiments, the UV light source or lamp is adapted to emit an irradiation intensity in the range of 1-500 mW/cm². The irradiation intensity may vary considerably depending on the type of lamp used. Higher intensities may improve the performance of the device (e.g., PECO device). However, the intensity may be so high that the system is UV-saturated or swamped and little or no further benefit is obtained. That optimum irradiation value or intensity may depend, at least in part, upon the distance between the lamp and one or more photoelectrodes.

The intensity (i.e., irradiance) of UV light at the photoelectrode may be measured using a photometer available from International Light Technologies Inc. (Peabody, Mass.), e.g., Model IL 1400A, equipped with a suitable probe. An example irradiation is greater than 3 mW/cm².

UV lamps typically have a “burn-in” period. UV lamps may also have a limited life (e.g., in the range of approximately 6,000 to 10,000 hours). UV lamps also typically lose irradiance (e.g., 10 to 40% of their initial lamp irradiance) over the lifetime of the lamp. Thus, it may be important to consider the effectiveness of new and old UV lamps in designing and maintaining oxidation values.

In various embodiments, device or apparatus 400 also includes an electrode assembly or module 600. In various embodiments, electrode assembly or module 600 includes a terminal assembly member 610, a counterelectrode 620, provided around a photoelectrode 630, with a separator 625 provided therebetween, a first terminal 640 coupled to photoelectrode 630 and a second terminal 650 coupled to counterelectrode 620. In various embodiments, counterelectrode 620 is provided around and/or outside of photoelectrode 630. Each of the terminals 640/650 is coupled to and/or adapted to receive a voltage, potential or bias. In various embodiments, the terminals 640/650, and/or at least a portion of photoelectrode 630, separator, and counterelectrode 620, are provided within a first cavity or volume defined by terminal assembly member 610. In various embodiments, terminal assembly member 610 defines a second cavity or volume 660 at least partially separated from the first volume by a dividing wall 665. Terminal assembly member 610 may also be coupled at one end to a terminal end cap 670. In various embodiments, second volume 660 may be utilized to at least partially house wiring coupled to a terminal assembly (no shown) provided through one or more apertures in dividing wall 665. In various embodiments, the terminal assembly and apertures through which the assembly is provided are sealed to prevent various undesirables or other elements to entering or exiting through apertures in dividing wall 665.

In various embodiments, terminal end cap 670 defines an aperture adapted to receive and/or into which a wiring guide or connector 655 and/or wiring electrically coupled to one or more terminals 640/650 may be provided. In various embodiments, terminal assembly member 610 defines an inlet and/or an outlet. In various embodiments, a tubing or other adapter 480 is provided in the inlet/outlet defined by terminal assembly member 610.

In various embodiments, bulb assembly 500 is substantially provided in and coupled to housing 410 at first opposing end 440 of housing 410. In various embodiments, electrode assembly 600 is provided within housing 410 at or through second opposing end 430 of housing 410 such that photoelectrode 630 is provided at least partially around the light tube or sleeve 520 of bulb assembly 500. In various embodiments, bulb assembly 500 and electrode assembly 600 may be coupled to housing 410 in a variety of ways. For example, one or more of the assemblies may be screwed onto threads or grooves on housing 410.

In one or more examples of embodiments, photoelectrode 630 is provided around light tube or sleeve 520. In various embodiments, photoelectrode 630 is provided (e.g., around light tube or sleeve 520) to optimize (e.g., minimize) the distance or separation between photoelectrode 630 and the UV light and/or tube or sleeve 520. In various embodiments, photoelectrode 630 is provided closely around or near a surface of light tube or sleeve 520.

In one or more examples of embodiments, photoelectrode 630 (e.g., a foil photoelectrode) is provided around light tube or sleeve 520 such that a majority of the UV light (e.g., from the UV source within light tube or sleeve 520) is directed at or otherwise exposed to photoelectrode 630. In various embodiments, photoelectrode 630 is provided around light tube or sleeve 520, such that a substantial portion of the UV light is exposed to and/or directed at photoelectrode 630. In various embodiments, photoelectrode 630 is provided relatively close to light tube or sleeve 520 such that less than half (e.g., a relatively small percentage) of any volume of solution in or flowing through housing 420 of reactor or device 400 is exposed to light directly from the UV light or UV source.

In various embodiments, photoelectrode 630 is provided relative to light tube or sleeve 520 such that most of the volume of cavity 450 of reactor or device 400 is between photoelectrode 630 and wall or sidewall 420. In various embodiments, photoelectrode 630 is provided relative to light tube or sleeve 520 such that most of the average cross-sectional area of cavity 450 is between photoelectrode 630 and wall or sidewall 420. In various embodiments, photoelectrode 630 is provided relative to light tube or sleeve 520 such that the average cross-sectional area between photoelectrode 630 and wall or sidewall 420 is greater than the average cross-sectional area between photoelectrode 630 and light tube or sleeve 520.

In various embodiments, photoelectrode 630 is provided around light tube or sleeve 520 such that it is closer to light tube or sleeve 520 than to sidewall 420 (e.g., to help promote or facilitate flow of most of solution in space between photoelectrode 630 and sidewall(s) 420. In various embodiments, the average distance or spacing between a surface of photoelectrode 630 nearest light tube or sleeve 520 and a surface of light tube or sleeve 520 nearest photoelectrode 630 is less than one-half inch. In various embodiments, the average distance or spacing between photoelectrode 630 and light tube or sleeve 520 is less than three-eighths of an inch.

Photoelectrode 630 may alternatively be spaced from light tube or sleeve 520. In various embodiments, photoelectrode 630 is provided relatively farther from light tube or sleeve 520 such that half or more of any volume of solution in or flowing through the housing of the reactor or device is exposed to light directly from the UV light or UV source.

In various embodiments, photoelectrode 630 is provided relative to light tube or sleeve 520 such that half or less of the volume of the cavity of the reactor or device is between photoelectrode 630 and wall or sidewall 420. In various embodiments, photoelectrode 630 is provided relative to light tube or sleeve 520 such that half or less of the average cross-sectional area of cavity 450 of the reactor or device 400 is between photoelectrode 630 and wall or sidewall 420. In various embodiments, photoelectrode 630 is provided relative to light tube or sleeve 520 such that the average cross-sectional area between photoelectrode 630 and wall or sidewall 420 is equal or less than the average cross-sectional area between photoelectrode 630 and light tube or sleeve 520. In various embodiments, a surface of light tube or sleeve 520 nearest photoelectrode 630 and a surface of photoelectrode 630 nearest light tube or sleeve 520 help define a first cross-sectional area and an opposing surface of photoelectrode 630 and a surface of the cavity wall define a second cross-sectional area, and wherein the first cross-sectional area is equal or larger than the second cross-sectional area. In various embodiments, the distance from the surface of photoelectrode 630 nearest light tube or sleeve 520 to the surface of light tube or sleeve 520 nearest photoelectrode 630 is more than the distance from the opposing surface of photoelectrode 630 to the surface of the cavity wall nearest photoelectrode 630.

In various embodiments, photoelectrode 630 includes a conductive support member and a film member. In one or more examples of embodiments, the conductive support member is constructed from metal (e.g. titanium or Ti). In various embodiments, the film member is nanoporous and includes a thin layer (e.g., 200-500 nm) of titanium dioxide (TiO₂) (e.g., a TiO₂ coating) that is provided and/or adapted to function as a photocatalyst. In various examples of embodiments, the film member has an average thickness in the range of 1-2000 nanometers. In one or more examples of embodiments, the film member has an average thickness in the range of 5 to 500 nanometers.

In various embodiments, the film member is provided on (e.g., coated on or adhered to) the conductive support member. In various embodiments, the film member has a median pore diameter in the range of 0.1-500 nanometers and is constructed from TiO₂ nanoparticles. In one or more examples of embodiments, the median pore diameter of the film member is in the range of 0.3-25 nanometers. In other examples of embodiments, the median pore diameter of the film member is in the range of 0.3-10 nanometers.

In various examples of embodiments, the film member is constructed from a stable, dispersed suspension comprising TiO₂ nanoparticles having a median primary particle diameter in the range of 1-50 nanometers. The nanoporous film may also be deposited by other methods, such as plasma, chemical vapor deposition or electrochemical oxidation. In one or more examples of embodiments, the TiO₂ nanoparticles have a median primary particle diameter in the range of 0.3-5 nanometers.

In various embodiments, the film member is constructed from a stable, dispersed suspension including a doping agent. Examples of suitable doping agents include, but are not limited to, Pt, Ni, Au, V, Sc, Y, Nb, Ta, Fe, Mn, Co, Ru, Rh, P, N and/or carbon.

In various examples of embodiments, the nanoporous film member is constructed by applying a stable, dispersed suspension having TiO₂ nanoparticles suspended therein. In various embodiments, the TiO₂ nanoparticles are sintered at a temperature in the range of 300 deg C. to 1000 deg C. for 0.5 to 24 hours. Example photoelectrodes may be prepared by coating Ti metal foil. Titanium foil is stable and may also be used to make photoelectrodes. One example of suitable Ti metal foil includes 15 cm×15 cm×0.050 mm thickness and 99.6+% (by weight) pure Ti metal foil commercially available from Goodfellow Corp. (Oakdale, Pa.) with a titania-based metal oxide. In various embodiments, the Ti metal foil is cleaned with a detergent solution, rinsed with deionized water, rinsed with acetone, and/or heat-treated at 350 deg C. for 4 hours providing an annealed Ti foil. Annealing may also be conducted at higher temperatures such as 500 deg C.

Following cleaning and/or pretreatment, in various embodiments, the metal foil may be dip-coated. For example, the metal foil may be dip-coated three to five times with an aqueous suspension of titania at a withdrawal rate of ˜3.0 mm/sec. After each application of coating, in various embodiments, the coated foil is air dried for about 10-15 min and then heated in an oven at 70 deg C. to 100 deg C. for about 45 min. After applying a final coating, in various embodiments, the coated foil is sintered at 300-600 deg C. (e.g., 300 deg C., 400 deg C. or 500 deg C.) for 4 hours at a 3 deg C./min ramp rate. The Ti foil may be dipped into suspensions of titania synthesized using methods disclosed in U.S. patent application Ser. Nos. 11/932,741 and 11/932,519, each of which is incorporated herein by reference in its entirety. In various embodiments, the optimized withdrawal speed is around 21.5 cm min⁻¹.

In addition, in one or more examples of embodiments of the photoelectrode, the stable, dispersed suspension is made by reacting titanium isopropoxide and nitric acid in the presence of ultrapure water or water purified by reverse osmosis, ion exchange, and one or more carbon columns. In various embodiments, the conductive support member is annealed titanium foil. Other conductive supports may be employed, such as conductive carbon or glass. In various other embodiments, the photoelectrode is constructed from an anatase polymorph of Ti or a rutile polymorph of Ti. In one or more examples of embodiments of the photoelectrode, the rutile polymorph of Ti is constructed by heating an anatase polymorph of Ti at a temperature in the range of 300 deg C. to 1000 deg C. for a sufficient time. In one or more examples of embodiments of the photoelectrode, the anatase polymorph of Ti is heated at 500 deg C. to 600 deg C. to produce the rutile polymorph of Ti.

In various embodiments, after the titanium support is provided with a layer or film of TiO₂, the composite electrode is air-heated at a high temperature, giving the nanoporous TiO₂ film a crystalline structure due to thermal oxidation. It is believed that the instant titania, when heated at 500 deg C., converts to a crystalline rutile polymorph structure. It is further believed that the instant TiO₂ heated at 300 deg C. converts to a crystalline anatase polymorph structure. In some PECO applications, rutile TiO₂ has substantially higher catalytic activity than the anatase TiO₂. Rutile TiO₂ may also have substantially higher catalytic activity with respect to certain contaminant such as ammonia.

In various embodiments, photoelectrode 630 is modified (e.g., to improve performance). In various embodiments, photoelectrode 630 (e.g., Ti foil) is modified to increase the surface area of photoelectrode 630 exposed to light such as UV light. For example, photoelectrode 630 may be corrugated or otherwise modified. As further examples, the photoelectrode may be wavy. The photoelectrode may include various other features or microfeatures to help optimize the surface exposed to UV light and/or help cause turbulence in fluid or solution about the photoelectrode.

In various embodiments, photoelectrode 630 modifications include corrugating or otherwise modifying photoelectrode 630, conductive support member or foil to produce a wave-like pattern (e.g., regular wave-like pattern) on the foil surface. In various embodiments, the height of a corrugation “wave” is from about 1-5 mm. For example, in various embodiments, corrugating the foil twice at right angles to each other produces a cross-hatched pattern on the foil surface.

In various embodiments, photoelectrode 630 modifications include holes or perforations made or provided in photoelectrode 630, conductive support member, or foil. In various embodiments, the holes or perforations are made or provided at regular intervals (e.g., 0.5 to 3 cm spacing between the holes).

Modifications of the photoelectrode may also include various microfeatures and/or microstructures. Accordingly to various embodiments, the modifications of the photoelectrode, conductive support member or foil may also include various microfeatures and/or microstructures that increase the relative surface area of the photoelectrode and/or increase or promote turbulence about the photoelectrode. For example, according to various embodiments, such microfeatures and/or microstructures include those that are disclosed in U.S. Patent Publication Nos. 20100319183 and 20110089604, each of which is incorporated herein by reference in its entirety, or such microfeatures and/or microstructures that are provided commercially from Hoowaki, LLC (Pendleton, S.C.). In various embodiments, the microfeatures may include microholes. In various embodiments, modifications of the photoelectrode include the formation of nanotubes (e.g., TiO₂ nanotubes) on the photoelectrode, conductive support member and/or foil such as, for example, those that are disclosed in U.S. Patent Publication No. 20100269894, which is incorporated herein by reference in its entirety.

As a result of the holes, the positioning, the corrugation, and other modifications, etc., the photoelectrode may help create turbulence in fluid flowing in and/or through the device. Additionally, one or more holes may allow oxidants generated or produced on or near a surface of photoelectrode 630 to more rapidly and effectively make their way into or otherwise reach or react with the fluid (e.g., aqueous solution) and/or contaminants therein.

In one or more examples of embodiments, the photoelectrode is in the form of a mesh (e.g., a woven mesh, such as a 40×40 twill weave mesh or 60×60 Dutch weave mesh, or a non-woven mesh). Multiple photoelectrodes may also be used to improve photocurrent and/or chlorine generation.

In various embodiments, a counterelectrode (e.g., cathode) 620 is provided between walls 420 and/or the cavity wall of cavity 450 defined by the housing and photoelectrode (e.g., photoanode) 630. In various embodiments, counterelectrode or cathode material 620 is in the form of a foil. However, in various embodiments, the counterelectrode or cathode material may be in the form of a wire, plate, cylinder, or in another suitable shape or form. In various embodiments, the counterelectrode may be corrugated and/or have other features to help cause or promote turbulence in fluid or solution in the cavity.

In one or more examples of embodiments, counterelectrode or cathode 620 is constructed from or includes Al, Pt, Ti, Ni, Au, stainless steel, carbon and/or another conductive metal.

In various embodiments, photoelectrode 630 and counterelectrode 620 are separated by a separator 625. Separator 625 may be used or otherwise provided to prevent shorting (e.g., electrical shorting). In one or more examples of embodiments, photoelectrode (e.g., anode) 630 and counterelectrode (e.g., cathode) 620 are separated by plastic or plastic mesh separator 625, although alternative separators (e.g., other dielectric material(s) or other separators accomplishing or tending to accomplish the same or similar purposes) may be acceptable for use with the device and system described herein. In the illustrated examples, and other example embodiments, counterelectrode (e.g., cathode) 620 is placed or otherwise provided “behind” the photoelectrode (e.g., anode) 630 relative to light tube or sleeve 520 or a light source (e.g., UV light source) (i.e., between housing 410 or sidewall 420 and photoelectrode 630). In various embodiments, space or spacing between electrodes, or other material or mechanical apparatus.may be utilized to prevent shorting.

In various embodiments, electrode assembly 600 also includes a spacer 700. An example of such a spacer is illustrated in FIGS. 15-18. As can be seen from FIGS. 15-18, spacer 700 includes an entrance end 710, an exit end 720 and a longitudinal axis running from entrance end 710 to exit end 720. In various embodiments, spacer 700 is divided into two concentric portions, peripheral concentric portion 730 and axial concentric portion 740. In various embodiments, peripheral concentric portion 730 is coupled to axial concentric portion 740 by one or more dividers 750. In various embodiments, dividers 750 and peripheral concentric portion 730 and axial concentric portion 740 form channels 760 through which a solution may flow (e.g., from entrance end 710 to exit end 720, or from exit end 720 to entrance end 710). In various embodiments, one or more dividers 750 are angled relative to the longitudinal axis of spacer 700. In various embodiments, one or more dividers 750 have alternative or varying cross-sectional shape from entrance end to exit end. In various embodiments, a groove 770 (e.g., a concentric groove) is defined by or otherwise provided in exit side 720 of peripheral concentric portion of spacer 700. In various embodiments, a flange 770 (e.g., a concentric flange) helps define groove 770.

Referring again to FIG. 14, in various embodiments, the axial concentric portion of spacer 700 is adapted to receive the light tube or sleeve. In various embodiments, the groove defined by the exit side of the peripheral concentric portion of spacer 700 is adapted to receive a portion or an edge of photoelectrode 620. In various embodiments, however, the groove defined by the exit side of the peripheral concentric portion of spacer 700 is adapted to receive a portion or an edge of photoelectrode 620 and a portion or an edge of separator 625. In various embodiments, counterelectrode 630 is provided around the outside of the flange. In various embodiments, the separator is also provided around the outside of the flange (e.g., sandwiched between the flange and the counterelectrode). In various embodiments, the flange of the spacer is adapted to help separate at least a portion of photoelectrode 620 and counterelectrode 630 (e.g., to prevent shorting or arcing near the edge of the electrode assembly) and otherwise protect at least a portion of photoelectrode 620 and/or counterelectrode 630 from being bent, damaged or otherwise compromised. In various embodiments, the one or more dividers are adapted to help direct, redirect, mix, stir or otherwise influence solution as it passes through the channels and/or the device. For example, the dividers may help to create a spiral flow of solution between photoelectrode 620 and light tube or sleeve 520. Such mixing or flow may be advantageous in many ways. For example, such mixing or flow may help to mix oxidants generated by the device into the solution. As another example, such mixing or flow may increase the residence time of the solution in the cavity of the device for even a solution of moderate velocity. It should also be noted that, while the spacer is shown near an end of electrode assembly, it or any number of spacers or modified spacers (e.g. spacers not having a flange or groove) may be utilized anywhere along photoelectrode 620 and/or light tube or sleeve 520.

Referring again to FIGS. 5-8, in various embodiments, apparatus or device 400 includes housing or control box 700. In various embodiments, control box 700 may house various components of the apparatus or device 400. For example, in various embodiments, control box 700 houses one or more power supplies. In various embodiments, control box 700 houses one or more controls, circuits or switches which may be utilized to operate apparatus or device and its components. In various embodiments, control box 700 includes one or more circuits (e.g., an H circuit), switches (e.g., a MOSFET) or other devices for reversing a potential or bias across photoelectrode 630 and/or counterelectrode 620. In various embodiments, control box 700 includes a door or other component or aperture for ease of accessing components housed within control box 700. Control box 700 may be provided with locks and/or handles or other hardware.

In various embodiments, control box 700 includes or defines a first connector 720. In various embodiments, control box 700 includes or defines a second connectors 710. For example, one or more connectors 710/720 may be coupled to or provided through control box 700 to allow internal components of control box 700 to be electrically coupled to one or more device or apparatus 400 components provided externally to control box 700. For example, in various embodiments, control box 700 includes or defines at least one connector 710 through which wiring is or may be provided or coupled for electrically coupling electrodes 620/630 within a device or apparatus 400 to one or more power supplies provided in control box 700. In various embodiments, the circuits, switches or other such devices are housed in control box 700 and electrically connected or coupled to components of the unit 400 (e.g. a photoelectrode, counterelectrode and/or terminals). In one or more examples of embodiments, increasing the applied voltage (e.g., to the electrodes) may increase photocurrent and chlorine production.

A power supply and/or at least one ballast may be provided in control box 700 for supplying power to a UV lamp and/or bulb assembly 500. The one or more power supplies in control box 700 may be an AC or DC power supply and may include a plurality of outputs. In one or more examples of embodiments, the power supply is a DC power supply. The power supply may be a mountable power supply which may be mounted to control box 700. Preferably, the power supply is small in size, is durable or rugged, and provides power sufficient to operate at least one UV-lamp included in the apparatus and/or to supply an applied voltage or bias to the electrodes according to the described methods.

The power supply or an additional power supply may be connected to the terminals of the electrodes described hereinabove via, for example cable connection to the terminals, for providing a current, potential, voltage or bias to the electrodes as described in the described methods.

In various embodiments, control box includes one or more visual displays. For example, in various embodiments, control box includes a voltage display 730. In various embodiments, control box includes a current display 740. One or more of the displays may also display other information. Further, one or more of the displays may display real-time information.

A temperature probe(s) may also be provided in one or more examples of embodiments. The temperature probe(s) may be positioned in the container and/or in the inner box. The temperature probe may monitor the temperature in the container or in the box or in the fluid within the respective container or box and communicate that temperature reading. Further the temperature probe may be in communication with a shut-off switch or valve which is adapted to shut the system down upon reaching a predetermined temperature.

A fluid level sensor(s) may also be provided which may communicate a fluid level reading. The fluid level sensor(s) may be positioned in the container and/or in the inner box. Further the fluid level sensor may be in communication with a shut-off switch or valve which is adapted to shut off the intake of fluid or engage or increase the outflow of fluid from the container upon reaching a predetermined fluid value.

In operation of the foregoing example embodiment, contaminated fluid, such as contaminated water, may be pumped or otherwise provided or directed into the housing or container of the PECO device of the system. The water may be circulated and/or recirculated within the housing or container. Multiple units, or reactors, may be connected and operated in series, which may result in increased space and time for contaminated fluid in the reactor(s) or device(s). Upon completion of processing, in various embodiments, the water exits the housing and container ready for use, or circulated or recirculated through the device, other device, or system of devices (e.g., the fresh water output subsystem), for further treatment or purification.

In various embodiments, in operation, the TiO₂ photocatalyst is illuminated with light having sufficient near UV energy to generate reactive electrons and holes promoting oxidation of compounds on the anode surface.

Any temperature of aqueous solution or liquid water is suitable for use with the exemplary embodiments of the device such as the instant PECO devices. In various embodiments, the solution or water is sufficiently low in turbidity to permit sufficient UV light to illuminate the photoelectrode.

In various embodiments, photocatalytic efficiency is improved by applying a potential (i.e., bias) across the photoelectrode and counterelectrode. Applying a potential may decrease the recombination rate of photogenerated electrons and holes. In various embodiments, an effective voltage range applied may be in the range of −1 V to +15 V. In various embodiments, an electrical power source is adapted to apply an electrical potential in the range of 4 V to 12 V across the photoelectrode and counterelectrode. In various embodiments, the electrical power source is adapted to generate an electrical potential in the range of 1.2 V to 3.5 V across the photoelectrode and counterelectrode (or, 0 to 2.3 V vs. a reference electrode).

For various applications, including for example high-salinity applications, it may be desirable to reverse (e.g., periodically or intermittently) the potential, bias, polarity and/or current applied to or between the photoelectrode and the counterelectrode (e.g., to clean the photoelectrode and/or counterelectrode, or to otherwise improve the performance of the photoelectrode, counterelectrode, or device). In various embodiments, by reversing the potential, bias, polarity and/or current, the photoelectrode is changed (e.g. from an anode) into a cathode and the counterelectrode is changed (e.g. from a cathode) into an anode.

For example, in various embodiments, initially positive voltage is electrically connected to a positive charge electrode and negative voltage is electrically connected to a negative charge electrode. After a first period of time, the positive voltage is electrically connected to the negative charge electrode and the negative voltage is electrically connected to the positive charge electrode. After a second period of time, the positive voltage is electrically connected back to the positive charge electrode and the negative voltage is electrically connected back to the negative charge electrode. This reversal process may be repeated as necessary or desired.

The length of the first period of time and the second period of time may be the same. In various embodiments, however, the length of the first period of time and the second period of time are different. In various embodiments, the first period of time is longer than the second period of time.

The length of the first and second periods of time depends on a variety of factors including salinity, application, voltage, etc. For example, fracking fluid or high salinity fluid applications may require relatively more frequent reversal of potential, bias, polarity and/or current compared to fresh water applications. In various embodiments, the lengths of the first period of time relative to the second period of time may be in a ratio of from 3:1 to 50:1, and in one or more further embodiments from 3:1 to 25:1, and in one or more further embodiments from 3:1 to 7:1. For example, in various embodiments, the first period of time and second period of time is about 5 minutes to about 1 minute. Fresh water applications may require relatively less frequent reversal of potential, bias, polarity and/or current, and the lengths of the first period of time relative to the second period of time may be in a ratio of from 100:1 to 10:1. For example, in various embodiments, the first period of time and second period of time is about 60 minutes to a range of about 1 minute to about 5 minutes.

In various embodiments, the voltage applied between the photoelectrode and counterelectrode may not change during the first period of time of normal potential and during the second period of time of reverse potential. For example, in various embodiments (e.g., where the photoelectrode includes titanium and the apparatus and/or method are adapted for treatment of fracking or other high salinity solution) the voltage applied during the first period of time may be less than 9V (e.g., about 7.5V) and the voltage applied during the second period of time may be less than 9V (e.g., about 7.5V). In other various embodiments (e.g., where the photoelectrode includes titanium and the apparatus and/or method are adapted for treatment of fresh water) the voltage applied during the first period of time may be greater than 9V (e.g., about 12V) and the voltage applied during the second period of time may be greater than 9V (e.g., about 12V).

Maintaining the voltage in the first period of time and the second period of time may help to maintain and/or un-foul the photoelectrode to help make it more effective for removing contaminants through photoelectrocatalytic oxidation during the first period of time. However, maintaining the voltage under 9V in each period of time may cause a momentary disturbance in the removal of contaminants during the second period of time. For a variety of reasons, (e.g., to help minimize any such disturbance and/or to help cause electroprecipitation and/or electrocoagulation), in various embodiments, it may be advantageous to apply higher voltages (e.g. voltages greater than 9V) during the first period of time and second period of time. In various embodiments, applying higher voltages helps to promote an electrochemical process such as electroprecipitation and/or electrocoagulation during the second period of time, which process can help minimize any disturbance in removal of contaminants during the second period of time as well as offer advantages and benefits of such a process.

In various embodiments, the voltage is adjusted to control the rate of dissolution of the electrode. In various examples of embodiments, the voltage applied during the first period of time may be more than 9V (e.g., about 12V) and the voltage applied during the second period of time may be more than 9V (e.g., about 12V). Higher voltages may help optimize the effectiveness of the device in certain ways. Higher voltages may also lead to electroprecipitation or electrocoagulation of contaminants within or from the fluid. However, such higher voltages may also lead to anodic dissolution such as pitting and other degradation of the photoelectrode and/or counterelectrode, which may necessitate more frequent servicing of the PECO device (e.g. replacement of the photoelectrode (e.g., the foil) and counterelectrode).

In various embodiments, it may be advantageous (e.g., to help limit any anodic dissolution, or pitting or other degradation of the photoelectrode) to apply relatively lower voltages during the first period of time and relatively higher voltages during the second period of time. In various embodiments, e.g., in a fracking fluid application using a photoelectrode and a counterelectrode including titanium, the voltage applied during the first period of time may be less than 9V (e.g., about 7.5V) and the voltage applied during the second period of time may be more than 9V (e.g., about 12V for fracking fluid or higher salinity applications, to about 14V for fresh water applications). In various embodiments, during application of relatively lower voltage during the first period of time, contaminants are degraded (or the removal of contaminants is promoted) by photoelectrocatalytic oxidation, and during application of a relatively higher voltage during the second period of time, contaminants are degraded (or the removal of contaminants is promoted) by an electrochemical process such as electroprecipitation and/or electrocoagulation.

In various embodiments, during the second period of time, the counterelectrode or sacrificial electrode of titanium is dissolved at least in part by anodic dissolution. It is believed that a range of coagulant species of hydroxides are formed (e.g. by electrolytic oxidation of the sacrificial counterelectrode), which hydroxides help destabilize and coagulate the suspended particles or precipitate and/or adsorb dissolved contaminants.

In various embodiments, it is advantageous to apply relatively higher voltages during the first period of time and relatively lower voltages during the second period of time. In various embodiments, the voltage applied during the first period of time is more than 9V (e.g., about 12V) and the voltage applied during the second period of time is less than 9V (e.g., about 7.5V).

In various embodiments, the main reaction occurring at the counterelectrodes or sacrificial electrodes during the second period of time (e.g., during polarity reversal) is dissolution:

TI₍ₛ₎→Ti⁴⁺+4e⁻

In addition, water is electrolyzed at the counterelectrode (or sacrificial electrode) and photoelectrode:

2H₂O+2e⁻→H_{2(g)}+2OH⁻ (cathodic reaction)

2H₂O→4H⁺+O_{2(g)}+4e⁻ (anodic reaction)

In various embodiments, electrochemical reduction of metal cations (Meⁿ⁺) occurs at the photoelectrode surface:

Meⁿ⁺+ne⁻→nMe°

Higher oxidized metal compounds (e.g., Cr(VI)) may also be reduced (e.g. to Cr(III)) about the photoelectrode:

Cr₂O₇²⁻+6e⁻+7H₂O→2Cr³⁺+14OH⁻

In various embodiments, hydroxide ions formed at the photoelectrode increase the pH of the solution which induces precipitation of metal ions as corresponding hydroxides and co-precipitation with metal (e.g. Ti) hydroxides:

Meⁿ⁺+nOH⁻Me(OH)ₙ₍ₛ₎

In addition, anodic metal ions and hydroxide ions generated react in the solution to form various hydroxides and built up polymers:

Ti⁴⁺+4OH⁻→Ti(OH)₄₍ₛ₎

nTi(OH)₄₍ₛ₎⁻Tiₙ(OH)₄ₙ₍ₛ₎

However, depending on the pH of the solution other ionic species may also be present. The suspended titanium hydroxides can help remove pollutants from the solution by sorption, co-precipitation or electrostatic attraction, and coagulation.
For a particular electrical current flow in an electrolytic cell, the mass of metal (e.g. Ti) theoretically dissolved from the counterelectrode or sacrificial electrode is quantified by Faraday's law

$$m = \frac{ItM}{zF}$$

where m is the amount of counterelectrode or sacrificial electrode material dissolved (g), I the current (A), t the electrolysis time (s), M the specific molecular weight (g mol⁻¹), z the number of electrons involved in the reaction and F is the Faraday's constant (96485.34 As mol⁻¹). The mass of evolved hydrogen and formed hydroxyl ions may also be calculated.

In various embodiments, it may be advantageous (e.g., to help limit any anodic dissolution, or pitting or other degradation of the photoelectrode) to apply certain voltages (e.g., relatively higher voltages) during the first period of time and different voltages (e.g., relatively lower voltages) during the second period of time. In various embodiments (e.g., in a fracking fluid application using a counterelectrode including aluminum), the voltage applied during the first period of time may be about 6V to 9V (e.g., about 7.5V) and the voltage applied during the second period of time may be about 0.6V-12V. In various embodiments, during application of relatively higher voltage during the first period of time, contaminants are degraded (or the removal of contaminants is promoted) by photoelectrocatalytic oxidation, and during application of a relatively lower voltage during the second period of time, contaminants are degraded (or the removal of contaminants is promoted) by and electrochemical process such electroprecipitation or electrocoagulation.

In various embodiments, during the second period of time, an aluminum counterelectrode or sacrificial electrode is dissolved at least in part by anodic dissolution. It is believed that a range of coagulant species of hydroxides are formed (e.g. by electrolytic oxidation of the sacrificial counterelectrode), which hydroxides help destabilize and coagulate the suspended particles or precipitate and/or adsorb dissolved contaminants.

In various embodiments, the main reaction occurring at the counterelectrodes or sacrificial electrodes during the second period of time (e.g., during polarity reversal) is dissolution:

Al₍ₛ₎→A1³⁺+3e⁻

Additionally, water is electrolyzed at the counterelectrode (or sacrificial electrode) and photoelectrode:

2H₂O+2e⁻→H_{2(g)}+2OH⁻ (cathodic reaction)

2H₂O→4H⁺+O_{2(g)}+4e⁻ (anodic reaction)

In various embodiments, electrochemical reduction of metal cations (Meⁿ⁺) occurs at the photoelectrode surface:

Meⁿ⁺+ne⁻→nMe°

Higher oxidized metal compounds (e.g., Cr(VI)) may also be reduced (e.g. to Cr(III)) about the photoelectrode:

Cr₂O₇²⁻+6e⁻+7H₂O→2Cr³⁺+14OH⁻

In various embodiments, hydroxide ions formed at the photoelectrode increase the pH of the solution which induces precipitation of metal ions as corresponding hydroxides and co-precipitation with metal (e.g. Al) hydroxides:

Meⁿ⁺+nOH⁻→Me(OH)ₙ₍ₛ₎

In addition, anodic metal ions and hydroxide ions generated react in the solution to form various hydroxides and built up polymers:

Al³⁺+3OH⁻→Al(OH)₃₍ₛ₎

nAl(OH)₃₍ₛ₎⁻→Alₙ(OH)₃₍ₛ₎

However, depending on the pH of the solution other ionic species, such as dissolved Al(OH)²⁺, Al₂(OH)₂⁴⁺ and Al(OH)₄⁻ hydroxo complexes may also be present. The suspended aluminum hydroxides can help remove pollutants from the solution by sorption, co-precipitation or electrostatic attraction, and coagulation.

For a particular electrical current flow in an electrolytic cell, the mass of metal (e.g. Al) theoretically dissolved from the counterelectrode or sacrificial electrode is quantified by Faraday's law

$$m = \frac{ItM}{zF}$$

where m is the amount of counterelectrode or sacrificial electrode material dissolved (g), I the current (A), t the electrolysis time (s), M the specific molecular weight (g mol⁻¹), z the number of electrons involved in the reaction and F is the Faraday's constant (96485.34 As mol⁻¹). The mass of evolved hydrogen and formed hydroxyl ions may also be calculated.

The present invention, in one or more examples of embodiments, is directed to methods of treating an aqueous solution having one or more contaminants therein to help remove or reduce the amounts of contaminants. In various embodiments, the method includes providing an aqueous solution comprising at least one contaminant selected from the group consisting of an organism, an organic chemical, an inorganic chemical, and combinations thereof and exposing the aqueous solution to photoelectrocatalytic oxidization.

Generally, the method for reducing the amount of contaminants in solution or fluid described includes introducing the solution into a housing or container or cell including: a UV light; a photoelectrode, wherein the photoelectrode comprises an anatase polymorph of titanium, a rutile polymorph of titanium, or a nanoporous film of titanium dioxide; and a cathode. The photoelectrode is irradiated with UV light, and a first potential is applied to the photoelectrode and counterelectrode for a first period of time. In various embodiments, a second potential is applied to the photoelectrode and counterelectrode for a second period of time. As a result, the contaminant amount in solution is reduced.

In various embodiments, one or more contaminants are oxidized by a free radical produced by a photoelectrode, and wherein one or more contaminants are altered electrochemically (e.g. by electroprecipitation or electrocoagulation). In various embodiments, one or more contaminants are oxidized by a chlorine atom produced by a photoelectrode. In various embodiments, one or more contaminants are altered electrochemically (e.g. by electroprecipitation or electrocoagulation).

In one or more embodiments, the apparatus and methods utilize photoelectrocatalytic oxidation, whereby a photocatalytic anode is combined with a counterelectrode to form an electrolytic cell. In various embodiments, when the instant anode is illuminated by UV light, its surface becomes highly oxidative. By controlling variables including, without limitation, chloride concentration, light intensity, pH and applied potential, the irradiated and biased TiO₂ composite photoelectrode may selectively oxidize contaminants that come into contact with the surface, forming less harmful gas or other compounds. In various embodiments, application of a potential to the photoelectrode provides further control over the oxidation products. Periodic or intermittent reversal of the potential may help further remove or reduce the amount of contaminants.

The disclosure is further illustrated in the following Examples which are presented for purposes of illustration and not of limitation.

### EXAMPLE 1

A system for treating a aqueous solutions including water and contaminants therein was assembled as described above and as more particularly shown in FIG. 2. Water was spiked with low levels of various contaminants and the water was sampled. The water was then provided into the system after the system was powered on and the system was run for one hour. The water in the system was again sampled and both samples were analyzed for various contaminants. The results of the two sampling analyses are shown in Table 1 below.

TABLE 1
Effects of System on Contaminants

| Chemical | Pretreat | Treated |
|---|---|---|
| Benzene | 0.83 | 0 |
| Bromodichloromethane | 1.2 | 0 |
| Chloroform | 1.0 | 0 |
| Dibromochloromethane | 1.2 | 0 |
| Trihalomethanes (total) | 3.5 | 0 |
| 1,4-dioxane | 11 | 1.4 |

### EXAMPLE 2

A system for treating a aqueous solutions including water and contaminants therein was assembled as described above and as more particularly shown in FIG. 2. Water was sampled at the input and analyzed. The water was then allowed to pass through a system in accordance with the above disclosure and sampled at the output. A Table comparing the contaminant levels at the input and the output follows.

TABLE 2

| | | Co (ppb) | |
|---|---|---|---|
| Chemical | Description | Inlet | Outlet |
| Adenovirus | Virus | 99.9% + kill | |
| Cryptosporidium | Protozoan | 99.9% + kill | |
| Escherichia coli (E coli.) | Bacteria | 99.9% + kill | |
| Atrazine | Herbicide | 800 | <10 |
| Benzene | VOC | 600 | <10 |
| Bisphenol A | Endocrine Disruptor | 600 | <10 |
| Carbamazepine | Pharmaceutical | 80 | <1 |
| Estradiol | Steroid, Endocrine Disruptor | 80 | <1 |
| Ethynylestradiol | Steroid, Endocrine Disruptor | 3 | <0.1 |
| Glyphosate | Herbicide | 5 | <0.1 |

The foregoing apparatus and method provides various advantages. The device may be provided in a portable container, permitting on-site water or fluid decontamination. Further, the device is modular in design and can be easily combined with other devices as needed. The device is also easy to fabricate and includes electrical connections which are easy to make. In the apparatus described, the cathode is positioned behind the anode and away from the scouring action of water flow, reducing or limiting scale accumulation. Additionally, the spacer or separator provided between the counterelectrode and photoelectrode reduces shorting caused by contact or proximity of the electrode. These and other advantages are apparent from the foregoing description and associated Figures.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

We claim:

1. A system for removing or reducing the level of contaminants in a solution comprising
a pump, a tank, a carbon filter, and a photoelectrocatalytic oxidation apparatus in fluid communication;
wherein the photoelectrocatalytic oxidation apparatus comprises:
a housing having first opposing end and a second opposing end and at least partially defining a cavity having a cavity wall and a cavity length;
a light tube provided within the cavity and adapted to help disburse or otherwise provide ultraviolet radiation over most of the cavity length;
a photoelectrode provided around the light tube; a counterelectrode provided in the space between the photoelectrode and the cavity wall, and a separator menas provided between the photoelectrode and counterelectrode;
wherein the photoelectrode comprises a primarily titanium foil support with a layer of titanium dioxide provided on at least one surface the photoelectrode; and
wherein the photoelectrode and counterelectrode are each coupled to a respective terminal adapted to be electrically coupled to a power supply.

2. The system of claim 1, the photoelectrocatalytic device further comprising a first end assembly member coupled to the first opposing end of the housing and further defining the cavity.

3. The system of claim 2, the photoelectrocatalytic device further comprising a second end assembly member coupled to the second opposing end of the housing and further defining the cavity.

4. The system of claim 1, wherein the light tube defines a light tube cavity adapted to at least partially receive an ultraviolet light source.

5. The system of claim 4, wherein an ultraviolet light source is provided within the light tube cavity.

6. The system of claim 1, wherein the photoelectrode and the terminal coupled thereto and the counterelectrode and the terminal coupled thereto are removably coupled to a terminal assembly member, and a separator is provided between the photoelectrode and counterelectrode to form an electrode assembly or module.

7. The system of claim 6, wherein the electrode assembly further comprises a spacer, the spacer comprising a peripheral concentric portion coupled to an axial concentric portion by at least one divider.

8. A system for removing or reducing the level of contaminants in a solution comprising:
a pump, a tank, and a carbon filter in fluid communication with a photoelectrocatalytic oxidation device;
wherein the photoelectrocatalytic oxidation device comprises:
a housing having a first end opposing a second and at least partially defining a cavity having a cavity wall and a cavity length;
a light tube provided within the cavity and adapted to help disburse or otherwise provide ultraviolet radiation over most of the cavity length;
a photoelectrode provided around the light tube, such that a portion of the light tube is received by the photoelectrode;
a separator provided around the photoelectrode, such that a portion of the photoelectrode is received by the separator; and
a counterelectrode provided around the separator, such that a portion of the separator is received by the counterelectrode;
wherein the photoelectrode comprises a primarily titanium foil support with a layer of titanium dioxide provided on at least one surface of the photoelectrode; and
wherein the photoelectrode and counterelectrode are each coupled to a respective terminal adapted to be electrically coupled to a power supply.

9. The system of claim 8, wherein the device further comprises a first end assembly member coupled to the first opposing end of the housing and further defining the cavity.

10. The system of claim 9, wherein the device further comprises a second end assembly member coupled to the second opposing end of the housing and further defining the cavity.

11. The system of claim 8, wherein the light tube defines a light tube cavity adapted to at least partially receive an ultraviolet light source.

12. The system of claim 8, wherein the photoelectrode and the terminal coupled thereto and the counterelectrode and the terminal coupled thereto are removably coupled to a terminal assembly member, and the separator is provided between the photoelectrode and counterelectrode to form an electrode assembly or module.

13. The system of claim 12, wherein the electrode assembly or module is removably coupled to the housing.

14. The system of claim 13, wherein the electrode assembly further comprises a spacer, the spacer comprising a peripheral concentric portion coupled to an axial concentric portion by at least one divider.

15. A system for reducing the level of contaminants in a solution comprising:
a pump, a tank, and a carbon filter in fluid communication with a photoelectrocatalytic oxidation device, the device comprising:
a housing defining a cavity, the cavity having a first cavity end opposing a second cavity end;
a light tube containing an ultraviolet light source provided in the cavity between the first and second cavity ends;
a photoelectrode provided in the cavity between the first and second cavity ends, the photoelectrode receives the light tube such that the photoelectrode substantially surrounds the light tube; and
a counterelectrode provided in the cavity between the first and second cavity ends, the counterelectrode receives the photoelectrode such that the counterelectrode substantially surrounds the photoelectrode and light tube;
and a means for preventing electrical short preventing between the photoelectrode and counterelectrode.

16. The system of claim 15, wherein the photoelectrode is a substantially titanium metal foil having a plurality of corrugations.
